(19) United States
(12) Patent Application Publication
(10) Pub. No.: US 2006/0130454 A1
(43) Pub. Date: Jun. 22, 2006

(54) Cooling system using gas turbine engine air stream

(75) Inventor: Chih Chieh Liang, Peoria, IL (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Caterpillar Inc.

(21) Appl. No.: 11/018,322

(22) Filed: Dec. 22, 2004

(51) Int. Cl. F02C 3/00

(52) U.S. Cl. 60/39.01

(57) ABSTRACT

A cooling system including a gas turbine engine compressor configured to generate an air stream and compress at least a portion of air contained in the air stream. The cooling system further includes at least one air filter configured to filter the air stream upstream from the gas turbine engine compressor, and at least one heat exchanger configured to provide cooling. The at least one heat exchanger is located in the air stream generated by the gas turbine engine compressor at a position downstream of the at least one air filter and upstream of the gas turbine engine compressor.

### TECHNICAL FIELD

The present disclosure relates generally to a cooling system using a gas turbine engine air stream and, more particularly, to a work machine cooling system for a work machine having an electric powertrain and a gas turbine engine.

### BACKGROUND

Work machines such as, for example, a work machine having ground engaging tracks, have many working components that must be sufficiently cooled during use of the work machine. For example, a work machine may generally include a powertrain system and a hydraulic system that generate heat during operation such that the powertrain and hydraulic systems must be cooled in order to prevent overheating and/or system failure. In particular, a powertrain having an electric powertrain system, for example, may include a power source, a generator, one or more electric motors, gear trains, a final drive, and braking devices. A hydraulic system may include one or more hydraulic actuators and/or hydraulic motors for operating one or more work implements such as, for example, a blade, a ripper, or a bucket, and/or a hydraulic steering motor for steering a work machine having ground engaging tracks. During operation of such a work machine, these powertrain and hydraulic system components produce heat; a relatively small amount of heat during idling and a relatively larger amount of heat during operation of the powertrain and/or hydraulic systems. For example, a power source such as, for example, a diesel engine, produces heat that must be cooled in a controlled fashion.

For some work machines, a hydraulic system may have its own self-contained cooling system for dissipating heat to enhance system performance and/or increase the longevity of the system components. Such a cooling system may include a cooling circuit containing hydraulic fluid, for example, oil, which circulates through the hydraulic system when operating the hydraulic components and which absorbs heat generated during their operation. The hydraulic fluid may be circulated through one or more hydraulic fluid coolers to remove the heat absorbed from the hydraulic components. A hydraulic fluid cooler may be a hydraulic fluid-to-water cooler, and heat from the hydraulic fluid may be absorbed by the water as it circulates through the hydraulic fluid cooler. The water, which has absorbed heat from the hydraulic fluid, may thereafter be cooled by circulating through, for example, a water-to-air radiator. The water-to-air radiator may be cooled by air blown across and/or through the radiator by a cooling fan, thereby removing heat from the water as it circulates through the radiator and expelling it to the surrounding atmosphere.

A work machine powertrain may include its own self-contained powertrain cooling system. For example, the power source of a work machine may be a diesel engine having a turbocharger for compressing the intake air prior to combustion to enhance the diesel engine's power and torque, and/or for reducing its exhaust emissions. In order to further enhance the diesel engine's power and torque and reduce exhaust emissions, compressed air from the turbocharger may be cooled via, for example, an air-to-air radiator before entering the diesel engine's combustion chamber. Furthermore, the diesel engine may include a cooling system for cooling the engine's cooling water and oil. The cooling water may be cooled via circulation through a jacket water radiator, which may be regulated by a thermostat, such that when the cooling water temperature is below a certain temperature, it will remain closed to prevent the cooling water from circulating through the jacket water radiator in order to bring the cooling water temperature up to operating temperature, and such that when the cooling water temperature is above a certain temperature, it will open, thereby allowing the cooling water to circulate through the jacket water radiator to reduce the cooling water temperature to a desired operating temperature. In addition, the diesel engine's oil may be cooled via, for example, an engine oil-to-water cooler. For example, the diesel engine's oil may be circulated through the diesel engine, absorbing heat from its operation and then through the engine oil cooler to reduce the engine oil's temperature by absorbing at least some of its heat via the cooling water.

The powertrain system may also be cooled, for example, via the cooling water. The powertrain system may include powertrain oil, which may be circulated through the powertrain components to absorb heat produced by the powertrain's operation. The powertrain's oil may then be circulated through a powertrain oil cooler, where the heat absorbed by the powertrain oil may be removed by the cooling water.

The cooling system described above may result in at least three, separate radiators: an air-to-air radiator for cooling the air compressed by the turbocharger, a jacket water radiator for cooling the cooling water in the diesel engine, and an oil cooler for cooling the powertrain system oil and/or hydraulic system oil. With unlimited space, the most effective way to arrange the three radiators such that they may have the highest potential for cooling the work machine's systems might be to arrange the three separate radiators in a parallel (e.g., side-by-side) fashion and to have one or more cooling fans forcing air through and/or across them.

Due to space constraints often associated with work machines, however, such an arrangement may not be possible. One possible alternative is to locate one or more of the radiators behind one another in a row, such as, for example, placing the powertrain system and hydraulic system radiators behind the air-to-air radiator. This, however, results in forcing the ambient air through the air-to-air radiator prior to forcing the ambient air though the powertrain system and hydraulic system radiators. Such an arrangement may result in at least two drawbacks. First, the air reaching the powertrain and hydraulic system radiator has already absorbed heat from the air-to-air radiator, thereby raising its temperature and resulting in less effective cooling of the powertrain system water and/or oil and/or the hydraulic system oil. Second, by virtue of being placed in a row, the air-to-air radiator and the powertrain and hydraulic system radiators require a longer space, which may not be available in the work machine and/or which may create other system packaging problems.

Another possible alternative arrangement might be to place one or more of the three radiators in a different location remote from the other radiators on the work machine where there is available space. This alternative arrangement, however, may not be optimum because, for example, an additional cooling fan may be needed at the remote location in order to force ambient air through the remotely-located radiator, and/or additional cooling fluid lines may be needed to transport the cooling fluid to the remote location, which may create additional costs and/or maintenance problems.

In addition to having potential space and packaging constraints, work machines often operate in dusty and/or muddy environments. As a result, the air available for cooling the various work machine components contain a relatively large amount of dust, dirt particles, and/or rocks, which may damage the various work machine components due to their relatively delicate nature.

One method of cooling a power system is described in U.S. Pat. No. 6,134,878 (the '878 patent) issued to Amako et al. on Oct. 24, 2000. The '878 patent describes a gas turbine driven power system including a generator, a hydraulic pump, and an air compressor connected to the gas turbine. All of the air introduced into the power system is subjected to heat exchange for cooling the inside of the system.

Although the method described in the '878 patent may eliminate the need for a cooling water system associated with diesel engine cooling, the '878 patent's method does not address the above-outlined constraints associated with work machines. Rather, the '878 patent is concerned with providing an alternative power system for use in remote geographic regions or for use as an emergency back-up power supply for buildings. Such applications do not necessarily address the above-outlined problems that may be associated with work machine cooling.

The disclosed cooling system for a work machine, on the other hand, is directed to overcoming one or more of the problems outlined above with respect to work machine cooling.

### SUMMARY OF THE INVENTION

In one aspect, the present disclosure includes a cooling system including a gas turbine engine compressor configured to generate an air stream and compress at least a portion of air contained in the air stream. The cooling system also includes at least one air filter configured to filter the air stream upstream from the gas turbine engine compressor, and at least one heat exchanger configured to provide cooling. The at least one heat exchanger is located in the air stream generated by the gas turbine engine compressor at a position downstream of the at least one air filter and upstream of the gas turbine engine compressor.

In another aspect, the present disclosure includes a work machine including an electric powertrain. The electric powertrain includes a gas turbine engine configured to generate mechanical energy. The gas turbine engine includes a compressor configured to generate an air stream and compress at least a portion of air contained in the air stream. The electric powertrain further includes a generator configured to convert mechanical energy from the gas turbine engine into electric energy, and an electric motor operably coupled to the generator and configured to supply torque to ground engaging members to propel the work machine. The electric powertrain further includes ground engaging members operably coupled to the electric motor. The work machine further includes a hydraulic system configured to operate at least one of a work implement and a steering motor, and at least one heat exchanger associated with the work machine. The at least one heat exchanger is located in the air stream generated by the compressor.

In yet another aspect, the disclosure includes a method of cooling a work machine having an electric powertrain including a gas turbine engine, an electric motor, and a generator, and a hydraulic system configured to operate at least one of a work implement and a steering motor. The method includes locating at least one heat exchanger operably coupled to at least one of the electric powertrain and the hydraulic system in an air stream created by the gas turbine engine.

### BRIEF DESCRIPTION OF THE DRAWINGS

FIG. 1 is a schematic block diagram of an exemplary embodiment of a work machine cooling system including a gas turbine engine; and

FIG. 2 is a schematic block diagram of an exemplary embodiment of a work machine cooling system including a gas turbine engine.

### DETAILED DESCRIPTION

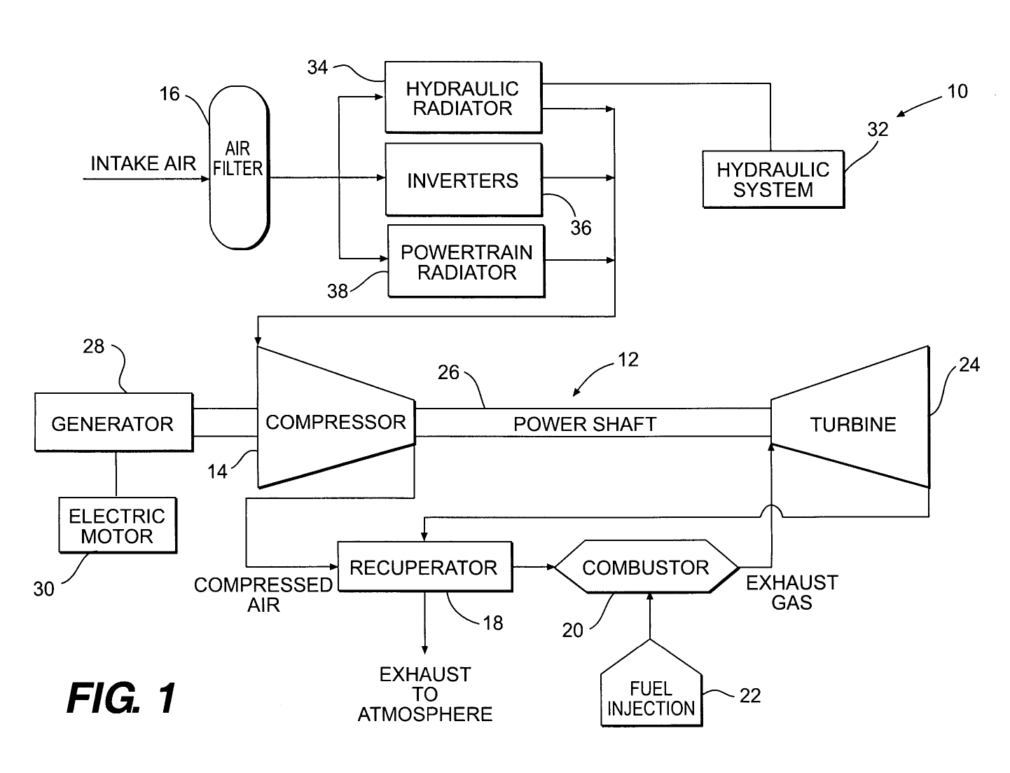

FIG. 1 illustrates an exemplary work machine 10 such as, for example, a track-type tractor, a track-type loader, a hydraulic excavator, a mining truck, a wheel loader, or another work machine known to those having skill in the art. Work machine 10 may include a gas turbine engine (GTE) 12 for providing mechanical energy to work machine 10. GTE 12 includes a compressor 14 configured to draw in a relatively large amount of intake air during operation and to compress the air drawn in. Work machine 10 may include one or more air filters 16 configured to substantially reduce the amount of dust, dirt particles, and/or rocks drawn into GTE 12. GTE 12 further includes a recuperator 18 configured to heat the compressed air received from compressor 14, and to exhaust air to the atmosphere. GTE 12 also includes a combustor 20 configured to receive heated, compressed air from the recuperator 18 and fuel from a fuel injection device 22, and then to ignite and burn the heated, compressed air and fuel, thereby creating an exhaust gas (e.g., a high energy gas). GTE 12 further includes a turbine 24 configured to convert energy from the exhaust gas into mechanical energy when the exhaust gas passes through turbine 24. Turbine 24 is operably coupled to a power shaft 26 configured to spin with turbine 24.

Work machine 10 may further include a generator 28 operably coupled to power shaft 26. Generator 28 may be configured to convert mechanical energy developed by GTE 12 into electric energy for use as a power source to power, for example, one or more electric motors 30 configured to propel work machine 10. Work machine 10 may be propelled via, for example, ground engaging members, such as, for example, wheels (not shown) and/or ground engaging tracks (not shown).

Work machine 10 may include a hydraulic system 32 configured to operate, for example, various work implements via hydraulic actuators and/or hydraulic motors, and/or a hydraulic steering motor configured to steer work machine 10 (e.g., a work machine having ground engaging tracks). Hydraulic system 32 may include a hydraulic system radiator 34, which may be, for example, a fluid-to-air radiator configured to cool hydraulic fluid (e.g., hydraulic oil) that may became heated during operation of the work implements and/or hydraulic motor.

Electric motor 30 and/or generator 28 may include inverters 36. Generator 28 and/or electric motor 30 may be brushless, sealed, and/or liquid cooled, and inverters 36 may be sealed and/or liquid cooled. Work machine 10 may further include a powertrain radiator 38, for example, an oil-to-air radiator, which may be configured to cool oil circulating through one or more of the various powertrain components of work machine 10.

Hydraulic system radiator 34, inverters 36, and/or powertrain radiator 38 may be located in work machine 10 such that they are exposed to an air stream created when compressor 14 draws in air. Further, air filter 16 may be located upstream relative to hydraulic system radiator 34, inverters 36, and/or powertrain radiator 38 such that the air stream passes through air filter 16 prior to exposure of hydraulic system radiator 34, inverters 36, and/or powertrain radiator 38 to the air stream.

Hydraulic system radiator 34, inverters 36, and/or powertrain radiator 38 may be arranged substantially parallel to one another (e.g., in side-by-side relation). For example, hydraulic system radiator 34, inverters 36, and/or powertrain radiator 38 may be arranged such that they are adjacent to one another, so that their respective exposure to the air stream is substantially unobstructed by one another, for example, as schematically depicted in FIG. 1.

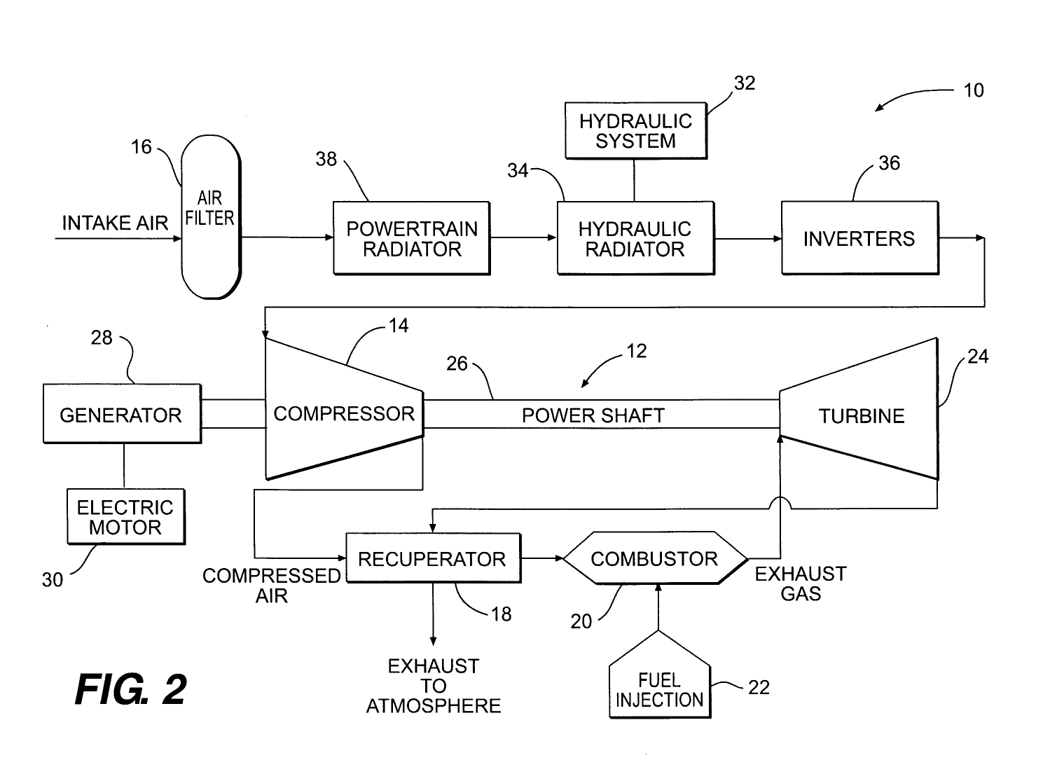

FIG. 2 illustrates an alternate embodiment of a work machine cooling system. One or more of hydraulic system radiator 34, inverters 36, and/or powertrain radiator 38 may be arranged in series such that one or more of hydraulic system radiator 34, inverters 36, and/or powertrain radiator 38 are arranged in a series fashion (e.g., facing front-to-back), for example, as schematically depicted in FIG. 2. In yet another alternative arrangement, hydraulic system radiator 34, inverters 36, and/or powertrain radiator 38 may be arranged in a combination of parallel and series arrangements.

### INDUSTRIAL APPLICABILITY

The disclosed work machine cooling system may be applicable to any system including a GTE and one or more devices that may benefit from cooling via air drawn in by the GTE's compressor. By virtue of a GTE's intake of a relatively large volume of filtered air, radiators and/or other devices associated with the system may be provided with sufficient amounts of filtered air, which may be substantially free from dust, dirt particles, and/or rocks to provide effective cooling while substantially avoiding potential damage to the radiators and/or other devices due to dust, dirt particles, and/or rocks. Operation of exemplary work machine cooling systems will now be explained.

In the exemplary work machine 10 schematically depicted in FIG. 1, GTE 12 provides mechanical power for work machine 10. GTE compressor 14 draws in and compresses a relatively large amount of intake air, which may be filtered by one or more air filters 16 to substantially prevent dust, dirt particles, and/or rocks from being drawn into compressor 14.

Once compressed by compressor 14, compressed air enters recuperator 18, where the compressed air may be heated by hot gas exhausted from turbine 24. Following heating, the compressed air may be fed into combustor 20, which may receive fuel from fuel injection device 22. Combustor 20 ignites the compressed air, thereby creating a heated exhaust gas (e.g., a high energy gas).

The heated exhaust gas may be passed through turbine 24, which converts energy in the heated exhaust gas into mechanical energy by rotating turbine 24 as the heated exhaust gas passes through turbine 24. Once it passes through turbine 24, the exhaust gas may be fed into recuperator 18 to heat compressed air entering recuperator 18 from compressor 14. The exhaust gas may thereafter be exhausted to the atmosphere.

Turbine 24 may be operably coupled to power shaft 26, for example, via direct connection, such that when turbine 24 spins in response to the flow of the heated exhaust gas, power shaft 26 is also rotated. Power shaft 26 is operably coupled to compressor 14 so that compressor 14 may continue to compress air drawn in through, for example, air filter 16. In addition to being operably coupled to compressor 14, power shaft 26 may be operably coupled to generator 28. Generator 28 converts mechanical energy developed by GTE 12 into electric energy for use as a power source to power, for example, one or more electric motors 30 configured to propel work machine 10, for example, via ground engaging members such as wheels and/or a pair of ground engaging tracks.

Hydraulic system 32 may operate various work implements via operation of hydraulic actuators and/or hydraulic motors, and/or may power a hydraulic steering motor configured to steer work machine 10 (e.g., a work machine having ground engaging tracks). During operation of the various implements and/or hydraulic motors, heat generated in the actuators and/or motors may be absorbed by hydraulic fluid contained in (e.g., circulating through) hydraulic system 32. Hydraulic system 32 may include a hydraulic system radiator 34 such as, for example, a fluid-to-air radiator, which cools hydraulic fluid that has been heated during operation of the work implements and/or hydraulic motors.

One or more electric motors 30 may provide torque for ground engaging members such as wheels and/or ground engaging tracks, such that work machine 10 is propelled. Electric motor 30 and/or generator 28 may include inverters 36. Generator 28 and/or electric motor 30 may be brushless, sealed and/or liquid cooled, and inverters 36 may be sealed and/or liquid cooled. Powertrain radiator 38 may be used to cool cooling fluid contained in (e.g., circulating through) one or more of generator 28, electric motor 30, and/or inverters 36, such that heat generated in them may be at least partially absorbed by the cooling fluid, which in turn, may be cooled via the powertrain radiator 38.

Hydraulic system radiator 34, inverters 36, and/or powertrain radiator 38 may be positioned and arranged in work machine 10 such that they are exposed to the air stream created by operation of compressor 14. Compressor 14 draws in a significantly larger volume of air than, for example, a diesel engine, such that excess air drawn in may be used to cool hydraulic system radiator 34, inverters 36, and/or powertrain radiator 38. By placing hydraulic system radiator 34 and powertrain radiator 38 in the air stream, the need for cooling fans and/or some cooling fluid lines may be substantially eliminated or reduced. As a result, the work machine cooling system may be less expensive, may require less maintenance, and/or may be more space efficient.

Hydraulic system radiator 34, inverters 36, and/or powertrain radiator 38 may be positioned and arranged in numerous and various configurations in work machine 10. For example, as schematically depicted in FIG. 1, hydraulic system radiator 34, inverters 36, and powertrain radiator 38 may be arranged in a substantially parallel arrangement such that each of these components is exposed to the filtered air stream without substantial obstruction from any of the other of these components. On the other hand, as schematically depicted in FIG. 2, the hydraulic system radiator 34, the inverters 36, and powertrain radiator 38 may be arranged in a series arrangement (e.g., one-behind-the-other) and in any order, depending on considerations such as, for example, space constraints, component packaging, ease of maintenance, and/or ease of gaining access to these components.

In addition, the air stream drawn in by compressor 14 may be substantially free from dust, dirt particles, and/or rocks, for example, by virtue of having been drawn through one or more air filters 16. Components such as hydraulic system radiator 34, inverters 36, and/or powertrain radiator 38 may be relatively easily damaged by dust, dirt particles, and/or rocks often associated with the environment in which work machines may operate. According to some aspects, these components may be exposed only to air that has been filtered by, for example, air filter 16, such that the air is substantially free from dust, dirt particles, and/or rocks, which may extend the useful life of these components by virtue of being cooled by a filtered air stream associated with GTE 12.

Furthermore, as distinguished from a diesel engine, for example, GTE 12 may not require additional lubrication or cooling beyond the air drawn into compressor 14. Whereas a diesel engine requires a cooling system including a jacket water radiator for absorbing heat in a cooling fluid, a separate oil cooler, and/or an air-to-air cooler for a turbocharger, GTE 12 may cool and lubricate itself using the relatively large volume of air drawn into compressor 14. As a result, using GTE 12 rather than a diesel engine, may result in the elimination of three cooling systems: a jacket water radiator for cooling the diesel engine's cooling water, an oil cooler for cooling the diesel engine's oil, and an air-to-air radiator for cooling air entering the diesel engine's turbocharger. As a result, work machine cooling system according to some aspects disclosed herein may be more space efficient and may require less maintenance.

It will be apparent to those skilled in the art that various modifications and variations can be made to the disclosed cooling system. For example, although the cooling system has been described in relation to a work machine, the cooling system may be used in conjunction with other systems that may benefit from cooling. Other embodiments will be apparent to those skilled in the art from consideration of the specification and practice of the disclosed cooling system. It is intended that the specification and examples be considered as exemplary only, with a true scope being indicated by the following claims and their equivalents.

What is claimed is:

1. A cooling system comprising:
a gas turbine engine compressor configured to generate an air stream and compress at least a portion of air contained in the air stream;
at least one air filter configured to filter the air stream upstream from the gas turbine engine compressor; and
at least one heat exchanger configured to provide cooling,
wherein the at least one heat exchanger is located in the air stream generated by the gas turbine engine compressor at a position downstream of the at least one air filter and upstream of the gas turbine engine compressor.

2. The cooling system of claim 1, wherein the at least one heat exchanger includes a heat exchanger configured to provide cooling for a hydraulic system.

3. The cooling system of claim 1, wherein the at least one heat exchanger includes a heat exchanger configured to provide cooling for an electric powertrain.

4. The cooling system of claim 3, wherein the electric powertrain includes an electric motor and a generator, and the at least one heat exchanger includes a heat exchanger configured to provide cooling for at least one of the electric motor and the generator.

5. The cooling system of claim 3, wherein the electric powertrain includes at least one inverter operably coupled to at least one of the electric motor and the generator and the at least one heat exchanger is configured to provide cooling for the at least one inverter.

6. The cooling system of claim 1, further including at least one air filter located in the air stream upstream relative to the at least one heat exchanger.

7. The cooling system of claim 1, wherein the at least one heat exchanger includes a first heat exchanger configured to be operably coupled to an electric powertrain and a second heat exchanger configured to be operably coupled to a hydraulic system, wherein the first and second heat exchangers are oriented in a parallel relationship relative to one another in the air stream.

8. The cooling system of claim 1, wherein the at least one heat exchanger includes a first heat exchanger configured to be operably coupled to an electric powertrain and a second heat exchanger configured to be operably coupled to a hydraulic system, wherein the first and second heat exchangers are oriented in a series relationship relative to one another in the air stream.

9. A work machine comprising:
an electric powertrain including,
a gas turbine engine configured to generate mechanical energy, the gas turbine engine including a compressor configured to generate an air stream and compress at least a portion of air contained in the air stream,
a generator configured to convert mechanical energy from the gas turbine engine into electric energy, and
an electric motor operably coupled to the generator and configured to supply torque to ground engaging members to propel the work machine,
ground engaging members operably coupled to the electric motor;
a hydraulic system configured to operate at least one of a work implement and a steering motor; and
at least one heat exchanger associated with the work machine,
wherein the at least one heat exchanger is located in the air stream generated by the compressor.

10. The work machine of claim 9, further including at least one air filter located upstream in the air stream relative to the at least one heat exchanger.

11. The work machine of claim 9, wherein the ground engaging members include a pair of ground engaging tracks.

12. The work machine of claim 9, further including at least one inverter operably coupled to at least one of the generator and the electric motor, wherein the at least one inverter is located in the air stream.

13. The work machine of claim 9, wherein the at least one heat exchanger is operably coupled to the hydraulic system.

14. The work machine of claim 9, wherein the at least one heat exchanger is operably coupled to at least one of the electric motor and the generator.

15. The work machine of claim 9, wherein the at least one heat exchanger includes a first heat exchanger operably coupled to the electric powertrain and a second heat exchanger operably coupled to the hydraulic system, wherein the first and second heat exchangers are oriented in a parallel relationship relative to one another in the air stream.

16. The work machine of claim 9, wherein the at least one heat exchanger includes a first heat exchanger operably coupled to the electric powertrain and a second heat exchanger operably coupled to the hydraulic system, wherein the first and second heat exchangers are oriented in a series relationship with respect to one another in the air stream.

17. The work machine of claim 9, wherein the at least one heat exchanger includes an oil-to-air radiator.

18. A method of cooling a work machine having an electric powertrain including a gas turbine engine, an electric motor, and a generator, and a hydraulic system configured to operate at least one of a work implement and a steering motor, the method comprising:
locating at least one heat exchanger operably coupled to at least one of the electric powertrain and the hydraulic system in an air stream created by the gas turbine engine.

19. The method of claim 18, wherein the electric powertrain further includes at least one inverter associated with at least one of the electric motor and the generator, wherein the method further includes placing the at least one inverter in the air stream.

20. The method of claim 18, further including filtering the air stream via at least one air filter located upstream relative to the location of the at least one heat exchanger.

21. A work machine comprising:
an electric powertrain including,
a gas turbine engine configured to generate mechanical energy, the gas turbine engine including a compressor configured to generate an air stream and compress at least a portion of air contained in the air stream,
a generator configured to convert mechanical energy from the gas turbine engine into electric energy, and
an electric motor operably coupled to the generator and configured to supply torque to ground engaging members to propel the work machine,
ground engaging members operably coupled to the electric motor;
a hydraulic system configured to operate at least one of a work implement and a steering motor;
a first heat exchanger operably coupled to the electric powertrain; and
a second heat exchanger operably coupled to the hydraulic system,
wherein the first and second heat exchangers are located in the air stream generated by the compressor.

22. The work machine of claim 21, wherein the first and second heat exchangers are oriented in a parallel relationship relative to one another in the air stream.

23. The work machine of claim 21, wherein the first and second heat exchangers are oriented in a series relationship relative to one another in the air stream.
